(19) United States
(12) Patent Application Publication
(10) Pub. No.: US 2025/0141253 A1
(43) Pub. Date: May 1, 2025

(54) PROCESSING APPARATUS OF BATTERY PACK AND ELECTRONIC DEVICE

(71) Applicant: GOPOD GROUP HOLDING LIMITED., Shenzhen (CN)

(72) Inventors: Zhuowen LIAO, Shenzhen (CN); Xingwang SONG, Shenzhen (CN)

(21) Appl. No.: 18/814,413

(22) Filed: Aug. 23, 2024

Related U.S. Application Data
(63) Continuation of application No. PCT/CN2023/133372, filed on Nov. 22, 2023.

(30) Foreign Application Priority Data
Oct. 30, 2023 (CN) 202311412338.3

(51) Int. Cl. H02J 7/00

(52) U.S. Cl. CPC H02J 7/0068; H02J 7/00032; H02J 7/0031

(57) ABSTRACT

In a processing apparatus of a battery pack, a first chip of a charging and discharging management circuit is electrically connected with a charging and discharging interface; a pin 11 of the first chip is electrically connected with a pin 24 of a second chip; a pin 12 of the first chip is electrically connected with a pin 23 of the second chip; a positive electrode of the battery pack is electrically connected with a pin 1 of a fifth chip, and a negative electrode of the battery pack is electrically connected with a pin 11, a pin CO and a pin 9 of the fifth chip; and a first signal output end of a battery pack communication circuit is electrically connected with a pin 13 of the second chip.

### CROSS-REFERENCE TO RELATED APPLICATIONS

The present disclosure claims the priority of the Chinese patent application filed on Oct. 30, 2023 to the China National Intellectual Property Administration with the application number of 202311412338.3 and the title of “PROCESSING APPARATUS OF BATTERY PACK AND ELECTRONIC DEVICE”, which is incorporated herein in its entirety by reference.

### TECHNICAL FIELD

The present disclosure relates to the technical field of batteries, in particular to a processing apparatus of a battery pack, and an electronic device.

### BACKGROUND OF THE PRESENT INVENTION

In a battery pack management system, it is often necessary to detect and control a state of a battery. At present, an I2C (Inter-Integrated Circuit) communication protocol is used to implement data exchange between a battery pack and a main control device. In order to meet higher voltage and capacity requirements, it is often necessary to stack a plurality of battery packs. In the prior art, there is a problem that using efficiency of the battery packs is relatively low.

### SUMMARY OF THE PRESENT INVENTION

In order to solve the above technical problems, the embodiments of the present disclosure provide a processing apparatus of a battery pack and an electronic device.

According to a first aspect, the embodiments of the present disclosure provide a processing apparatus of a battery pack, comprising:
a charging and discharging management circuit, a logic control circuit, a battery pack protection circuit and a battery pack communication circuit, wherein:
the charging and discharging management circuit comprises a first chip and a charging and discharging interface, and the first chip is electrically connected with the charging and discharging interface;
the logic control circuit comprises a second chip;
a pin 11 of the first chip is electrically connected with a pin 24 of a second chip; and a pin 12 of the first chip is electrically connected with a pin 23 of the second chip;
the battery pack protection circuit comprises a fifth chip, a lithium battery protection circuit and a battery pack turn-off protection circuit, a positive electrode of the battery pack is electrically connected with a pin 1 of the fifth chip, and a negative electrode of the battery pack is electrically connected with a pin 11, a pin CO and a pin 9 of the fifth chip through the lithium battery protection circuit;
a first signal output end of the battery pack communication circuit is electrically connected with a pin 13 of the second chip; and a second signal output end of the battery pack communication circuit is electrically connected with a pin 14 of the second chip;
the battery pack communication circuit is used for sending a control signal to the second chip through the first signal output end and the second signal output end; and
the second chip is used for determining series connection or parallel connection of the battery pack according to the control signal.

In some embodiments, the battery pack communication circuit comprises a switch module, the switch module comprises a twelfth field-effect tube and a thirteenth field-effect tube, and a connection point of a source of the twelfth field-effect tube and a source of the thirteenth field-effect tube is electrically connected with a pin 15 of the second chip; and
the second chip is used for controlling the switch module to be switched on or off after determining series connection or parallel connection of the battery pack.

In some embodiments, the battery pack communication circuit comprises a sixth chip, and a pin 8 of the sixth chip is electrically connected with a pin 16 of the second chip; and a pin 1 of the sixth chip is electrically connected with a pin 15 of the second chip;
the second chip is used for sending an enable signal to the pin 1 of the sixth chip to start the sixth chip after determining series connection or parallel connection of the battery pack; and
the sixth chip is used for sending a read output current value of the sixth chip to the pin 15 of the second chip.

In some embodiments, the charging and discharging interface comprises an activation module, the activation module comprises a twelfth resistor, a second field-effect tube, an eleventh resistor, a thirteenth resistor and a seventeenth capacitor, a first end of the twelfth resistor is used for connecting with a power supply, a second end of the twelfth resistor is electrically connected with a base of the second field-effect tube, an emitter of the second field-effect tube is grounded, a grid of the second field-effect tube is electrically connected with a first end of the eleventh resistor and a first end of the thirteenth resistor, a second end of the thirteenth resistor is grounded, a first end of the seventeenth capacitor is electrically connected with the second end of the thirteenth resistor, a connection point of a second end of the seventeenth capacitor and a second end of the eleventh resistor is a control end of the activation module, and the control end of the activation module is electrically connected with an output end of the charging and discharging interface.

In some embodiments, the apparatus further comprises: a voltage control circuit, wherein the voltage control circuit comprises a third chip and a fourth chip, and a connection point of a pin 3 and a pin 5 of the fourth chip is electrically connected with a pin 16 of the third chip; a pin 4 of the fourth chip is electrically connected with a pin 10 of the second chip; and a pin 6 of the fourth chip is electrically connected with a pin 11 of the second chip; and
a fourth chip used for judging whether a device is inserted into the charging and discharging interface, and if a device is inserted, sending a corresponding level to the second chip.

In some embodiments, the fourth chip is further used for judging whether the charging and discharging is in a single-interface state or a dual-interface state, and when the charging and discharging is in the single-interface state, a TypeC interface or a USB interface has a fast charging function; and when the charging and discharging is in the dual-interface state, the TypeC interface and the USB interface have the fast charging function.

In some embodiments, the battery pack turn-off protection circuit comprises a seventh field-effect tube, a sixty-fifth resistor and a sixty-ninth resistor, a base of the seventh field-effect tube is electrically connected with a pin 14 of the fifth chip through the sixty-fifth resistor, an emitter of the seventh field-effect tube and a first end of the sixty-ninth resistor are grounded, and a connection point of a grid of the seventh field-effect tube and a second end of the sixty-ninth resistor is connected with a pin 2 of the second chip.

In some embodiments, the apparatus further comprises: a Bluetooth power supply module, wherein the Bluetooth power supply module comprises an amplifier and a Bluetooth module, an input end of the amplifier is used for receiving a battery voltage, and an output end of the amplifier is electrically connected with the Bluetooth module; and
the Bluetooth power supply module is used for locating a device position.

In some embodiments, the apparatus further comprises: a lighting and sampling circuit, wherein the lighting and sampling circuit comprises a seventh chip, and a pin 6 of the seventh chip is electrically connected with a pin 27 of the second chip; and
the lighting and sampling circuit is used for detecting whether a load exists.

According to a second aspect, the embodiments of the present disclosure provide an electronic device comprising the processing apparatus of the battery pack provided in the first aspect.

According to the processing apparatus of the battery pack and the electronic device provided by the present disclosure above, the charging and discharging management circuit comprises the first chip and the charging and discharging interface, and the first chip is electrically connected with the charging and discharging interface; the logic control circuit comprises the second chip; the pin 11 of the first chip is electrically connected with the pin 24 of the second chip; the pin 12 of the first chip is electrically connected with the pin 23 of the second chip; the battery pack protection circuit comprises the fifth chip, the lithium battery protection circuit and the battery pack turn-off protection circuit, the positive electrode of the battery pack is electrically connected with the pin 1 of the fifth chip, and the negative electrode of the battery pack is electrically connected with the pin 11, the pin CO and the pin 9 of the fifth chip through the lithium battery protection circuit; the first signal output end of the battery pack communication circuit is electrically connected with the pin 13 of the second chip; the second signal output end of the battery pack communication circuit is electrically connected with the pin 1 4 of the second chip; the battery pack communication circuit is used for sending the control signal to the second chip through the first signal output end and the second signal output end; and the second chip is used for determining series connection or parallel connection of the battery pack according to the control signal. Series connection or parallel connection of the battery pack can be realized, and a working efficiency of the battery pack is improved.

### DESCRIPTION OF THE DRAWINGS

In order to more clearly illustrate the technical solutions of the embodiments of the present disclosure, the drawings needed in the embodiments will be briefly introduced below. It should be understood that the drawings below only illustrate some embodiments of the present disclosure, and should not be regarded as limiting the protection scope of the present disclosure. In the various drawings, similar constituent parts employ similar numerals.

FIG. 1 illustrates a schematic structural diagram of a processing apparatus of a battery pack provided by the embodiments of the present disclosure;

FIG. 2A illustrates a partial schematic structural diagram of a charging and discharging management circuit provided by the embodiments of the present disclosure;

FIG. 2B illustrates another partial schematic structural diagram of the charging and discharging management circuit provided by the embodiments of the present disclosure;

FIG. 3 illustrates a schematic structural diagram of a logic control circuit provided by the embodiments of the present disclosure;

FIG. 4 illustrates a schematic structural diagram of a battery pack protection circuit provided by the embodiments of the present disclosure;

FIG. 5 illustrates a schematic structural diagram of a voltage control circuit provided by the embodiments of the present disclosure;

FIG. 6 illustrates a schematic structural diagram of a battery pack communication circuit provided by the embodiments of the present disclosure;

FIG. 7 illustrates another schematic structural diagram of the battery pack communication circuit provided by the embodiments of the present disclosure;

FIG. 8 illustrates a schematic structural diagram of a Bluetooth power supply circuit provided by the embodiments of the present disclosure; and

FIG. 9 illustrates a schematic structural diagram of a lighting and sampling circuit provided by the embodiments of the present disclosure.

Description of numerals of main components: 1—processing apparatus of battery pack; 10—charging and discharging management circuit; 101—charging and discharging interface; 20—logic control circuit; 30—battery pack protection circuit; 301—lithium battery protection circuit; 302—battery pack turn-off protection circuit; 102—activation module; 40—voltage control circuit; 50—battery pack communication circuit; 60—Bluetooth power supply module; and 70—lighting and sampling circuit.

### DETAILED DESCRIPTION OF PREFERRED EMBODIMENTS

The following clearly and completely describes the technical solutions in the embodiments of the present disclosure with reference to the drawings in the embodiments of the present disclosure. Apparently, the described embodiments are merely some but not all of the embodiments of the present disclosure.

Components of the embodiments of the present disclosure, which are generally described and illustrated in the drawings herein, can be arranged and designed in various different configurations. Therefore, the following detailed description of the embodiments of the present disclosure provided in the drawings is not intended to limit the scope of the present disclosure claimed, but merely represents selected embodiments of the present disclosure. Based on the embodiments of the present disclosure, all other embodiments obtained by those having ordinary skills in the art without going through any creative work shall fall within the scope of protection of the present disclosure.

Hereinafter, the terms “comprising”, “having” and cognates thereof, which can be used in various embodiments of the present disclosure, are only intended to indicate specific features, numbers, steps, operations, elements, components or combinations of the foregoing items, and should not be understood as first excluding the existence of one or more other features, numbers, steps, operations, elements, components or combinations of the foregoing items or the probability of adding one or more features, numbers, steps, operations, elements, components or combinations of the foregoing items.

Moreover, the terms “first”, “second”, “third”, and the like are used for distinguishing descriptions only and cannot be understood as indicating or implying relative importance.

Unless otherwise defined, all terms (including technical terms and scientific terms) used herein have the same meaning as commonly understood by those of ordinary skills in the art to which various embodiments of the present disclosure belong. The terms (such as terms defined in commonly used dictionaries) will be interpreted as having the same meaning as the context meaning in the relevant technical field and will not be construed as having an idealized meaning or overly formal sense unless expressly defined in the various embodiments of the present disclosure.

### Embodiment 1

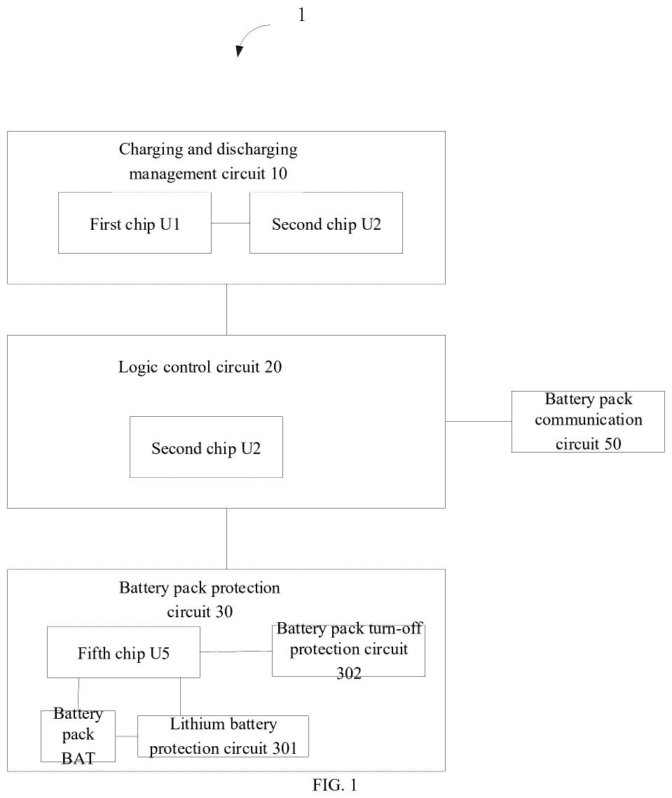

The embodiments of the present disclosure provide a processing apparatus 1 of a battery pack. Description will be made below with reference to FIG. 1 to FIG. 9.

Referring to FIG. 1 to FIG. 9, the processing apparatus 1 of the battery pack comprises: a charging and discharging management circuit 10, a logic control circuit 20, a battery pack protection circuit 30 and a battery pack communication circuit 50.

The charging and discharging management circuit 10 comprises a first chip U1 and a charging and discharging interface 101, and the first chip U1 is electrically connected with the charging and discharging interface 101.

The logic control circuit 20 comprises a second chip U2; a pin 11 of the first chip U1 is electrically connected with a pin 24 of a second chip U2; and a pin 12 of the first chip U1 is electrically connected with a pin 23 of a second chip U2. The pin 11 of the first chip U1 is an SDA pin. The pin 12 of the first chip U1 is an SCK pin. The pin 23 of the second chip U2 is a PT21/AIN9 pin. The pin 24 of the second chip U2 is a PT20/AIN8 pin.

The battery pack protection circuit 30 comprises a fifth chip U5, a lithium battery protection circuit 301 and a battery pack turn-off protection circuit 302, a positive electrode of the battery pack BAT1 is electrically connected with a pin 1 of the fifth chip U5, and a negative electrode of the battery pack BAT1 is electrically connected with a pin 11, a pin CO and a pin 9 of the fifth chip U5 through the lithium battery protection circuit. The pin 1 of the fifth chip U5 is a VDD pin, the pin 11 of the fifth chip U5 is a VM pin, the pin CO of the fifth chip U5 is a control voltage end, and the pin 9 of the fifth chip U5 is a DO pin.

A first signal output end BAT-SDA of the battery pack communication circuit 50 is electrically connected with a pin 13 of the second chip U2; and a second signal output end BAT-SCL of the battery pack communication circuit 50 is electrically connected with a pin 14 of the second chip U2. The pin 13 of the second chip U2 is a PT36/AIN6/RX/DMC pin. The pin 14 of the second chip U2 is a PT35/AIN5/TX/DPC pin.

The battery pack communication circuit 50 is used for sending a control signal to the second chip U2 through the first signal output end and the second signal output end; and
the second chip U2 is used for determining series connection or parallel connection of the battery pack according to the control signal.

The charging and discharging interface 101 comprises a USB interface and a TypeC interface. The TypeC interface and the first chip U1 form a charging and discharging DC-DC converter (DCDC) of a battery. The TypeC interface is a chargeable and dischargeable interface, which is a standard TypeC interface.

The first chip U1 acquires an electric quantity and a voltage of the battery, and the pin 11 and the pin 12 of the first chip U1 are electrically connected with the pin 23 and the pin 24 of the second chip U2. The pin 11 and the pin 12 of the first chip U1 are respectively an SDA pin and an SCK pin. The pin 23 and the pin 24 of the second chip U2 are respectively a PT21/AIN9 pin and a PT20/AIN8 pin.

The second chip U2 is used for acquiring a voltage and a current from the first chip U1, performing logic management on charging and discharging, and controlling the charging and discharging, and the second chip U2 acquires the voltage and the current of the battery to determine a charging and discharging power.

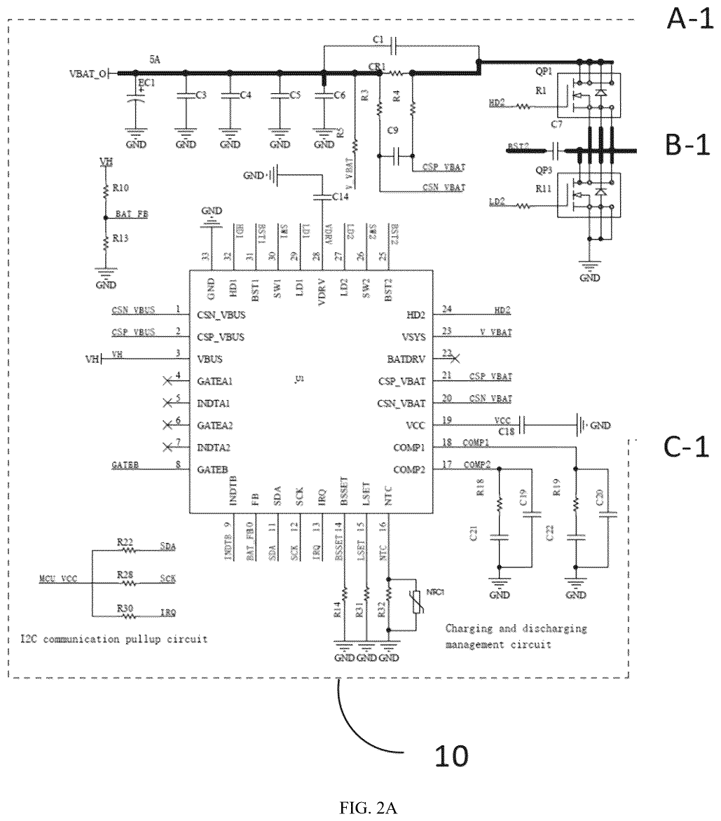

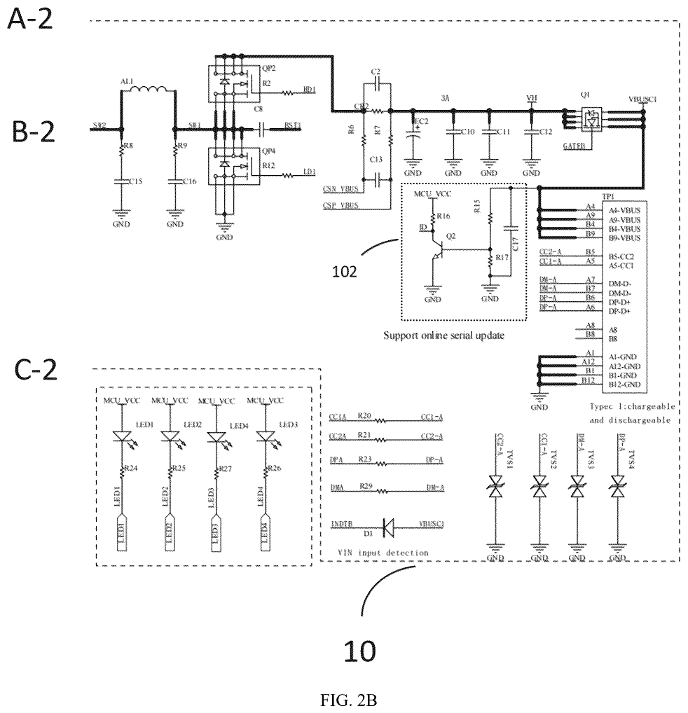

Referring to FIG. 2A and FIG. 2B, an overall schematic structural diagram of the charging and discharging management circuit is obtained by aligning a cut-off point A-1 of FIG. 2A with a cut-off point A-2 of FIG. 2B, aligning a cut-off point B-1 of FIG. 2A with a cut-off point B-2 of FIG. 2B, and aligning a cut-off point C-1 of FIG. 2A with a cut-off point C-2 of FIG. 2B.

The charging and discharging interface 101 comprises an activation module 102. The activation module 102 comprises a twelfth resistor R12, a second field-effect tube Q2, an eleventh resistor R11, a thirteenth resistor R13 and a seventeenth capacitor C17. A first end of the twelfth resistor R12 is used for connecting with a power supply MCU-VCC, a second end of the twelfth resistor R12 is electrically connected with a base of the second field-effect tube Q2, an emitter of the second field-effect tube Q2 is grounded, a grid of the second field-effect tube Q2 is electrically connected with a first end of the eleventh resistor R11 and a first end of the thirteenth resistor R13, a second end of the thirteenth resistor R13 is grounded, a first end of the seventeenth capacitor C17 is electrically connected with the second end of the thirteenth resistor R13, a connection point of a second end of the seventeenth capacitor C17 and a second end of the eleventh resistor R11 is a control end of the activation module 102, and the control end of the activation module 102 is electrically connected with an output end of the charging and discharging interface 101.

In this embodiment, devices with non-standard TypeC interfaces only comprise devices with vbus and gnd, and the second chip U2 is activated by the activation module 102 to realize insertion identification of the non-standard devices. In the integrated charging and discharging management circuit composed of FIG. 2A and FIG. 2B, QP1, QP2, QP3 and QP4 are power tubes for stepping up and down of voltage. In FIG. 2A, VBAT_O represents a battery voltage. When the battery voltage VBAT-O enters the charging and discharging management circuit 10, for example, is 9 V, 15 V or 20 V, the power tubes QP1 and QP4 are switched on and are in a step-down state. QP1 enters QP4 from SW2 through 15 uH inductance and SW1 to form a step-down state, and reaches the TypeC interface from QP2 to form a step-down state. LD1/HD1 is a driving voltage provided by the first chip U1 and is at a high level or a low level, with the high level being switched-on and the low level being switched-off. In FIG. 2B, LED1 to LED4 are electric quantity indicators, for example, representing 25%, 50%, 75%, 100% by number of the indicators that are turned on. TVS1 to TVS4 form an anti-surge protection circuit to prevent ESD surge.

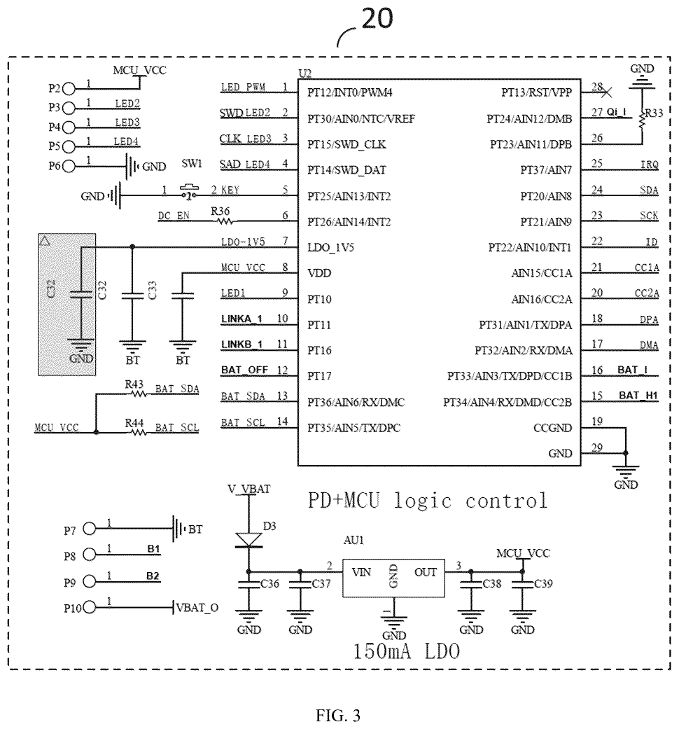

Referring to FIG. 3, the logic control circuit 20 comprises the second chip U2 and a first amplifier AU1. The second chip U2 is also connected with other chips. A pin 2 of the first amplifier AU1 is connected with a V-VBAT end through a third diode D3, and a pin 3 of the first amplifier AU1 is connected with an MCU_VCC end to achieve MCU logic control. A pin 1 of the first amplifier AU1 is a GND pin, the pin 2 of the first amplifier AU1 is a VIN pin, and the pin 3 of the first amplifier AU1 is an OUT pin.

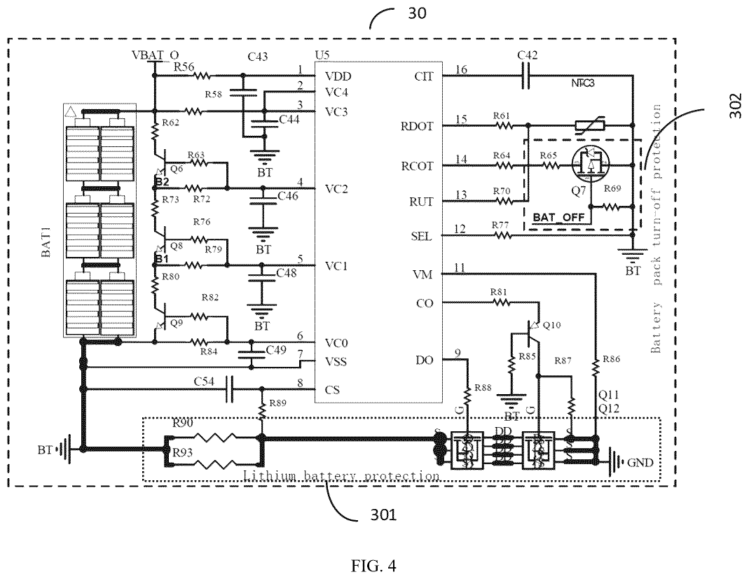

Referring to FIG. 4, the battery pack protection circuit 30 comprises a lithium battery protection circuit 301 and a battery pack turn-off protection circuit 302. A pin 1 of the first amplifier AU1 is a GND pin, the pin 2 of the first amplifier AU1 is a VIN pin, and the pin 3 of the first amplifier AU1 is an OUT pin. The battery pack turn-off protection circuit 302 comprises a seventh field-effect tube Q7, a sixty-fifth resistor R65 and a sixty-ninth resistor R69. A base of the seventh field-effect tube Q7 is electrically connected with a pin 14 of the fifth chip U5 through the sixty-fifth resistor R65, an emitter of the seventh field-effect tube Q7 and a first end of the sixty-ninth resistor R69 are grounded, and a connection point of a grid of the seventh field-effect tube Q7 and a second end of the sixty-ninth resistor R69 is connected with a pin 2 of the second chip. The pin 14 of the fifth chip U5 is an RCOT pin. The pin 2 of the second chip is a PT30/AIN0/NTC/VREF pin.

The battery pack protection circuit 30 protects the battery, for example, in terms of battery overvoltage and overcharge.

The fifth chip U5 controls voltages output by the TypeC interface and the USB interface, specifically, controls the voltages based on a communication protocol, and controls a single-interface state (TypeC interface or USB interface) or a dual-interface state (TypeC interface and USB interface).

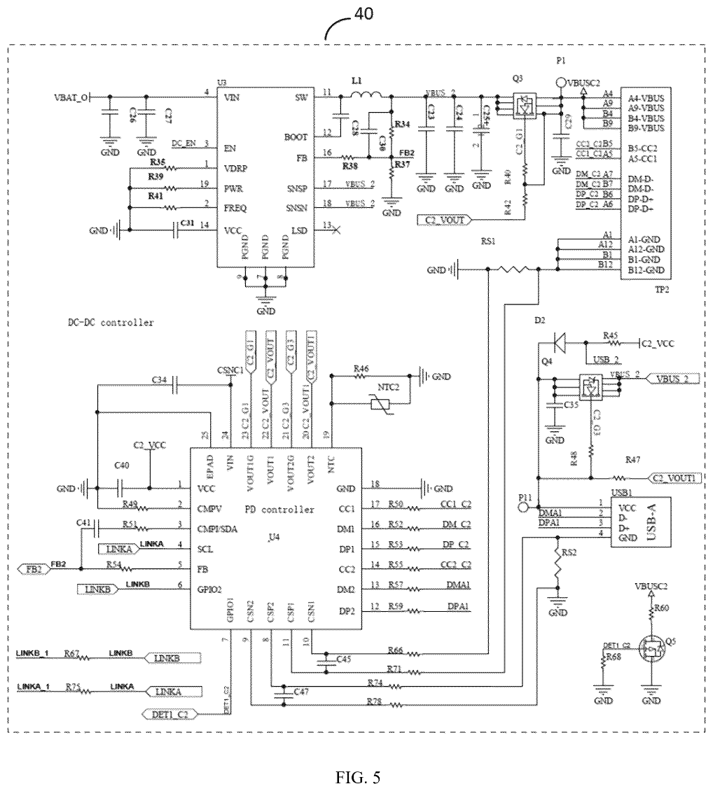

FIG. 5 shows a voltage control circuit 40. The voltage control circuit 40 comprises a third chip U3 and a fourth chip U4, and a connection point of a pin 3 and a pin 5 of the fourth chip U4 is electrically connected with a pin 16 of the third chip U3. A pin 4 (LINKA1 signal) of the fourth chip U4 is electrically connected with a pin 10 (LINKA_1 signal) of the second chip U2. A pin 6 (LINKB signal) of the fourth chip U4 is electrically connected with a pin 11 (LINKB_1 signal) of the second chip U2. The pin 11 of the second chip U2 is a PT16 pin. The pin 16 of the second chip is an FB pin. The pin 3 and the pin 5 of the fourth chip U4 are respectively a CMPI/SDA pin and an FB pin. The pin 4 of the fourth chip U4 is an SCL pin.

The fourth chip U4 is used for judging whether a device is inserted into the charging and discharging interface 101, and if a device is inserted, sending a corresponding level to the second chip U2.

In some embodiments, the fourth chip U4 is further used for judging whether the charging and discharging is in a single-interface state or a dual-interface state, and when the charging and discharging is in the single-interface state, a TypeC interface or a USB interface has a fast charging function. When the charging and discharging is in the dual-interface state, the TypeC interface and the USB interface have the fast charging function.

In this embodiment, the TypeC interface charges a device end or a battery pack, and is a chargeable and dischargeable interface.

The third chip U3 is a step-down IC, which is responsible for outputting electric energy to the TypeC interface and the USB interface. The TypeC interface outputs electric energy to a mobile phone or tablet, charges externally, and outputs the battery voltage after the battery voltage is stepped down.

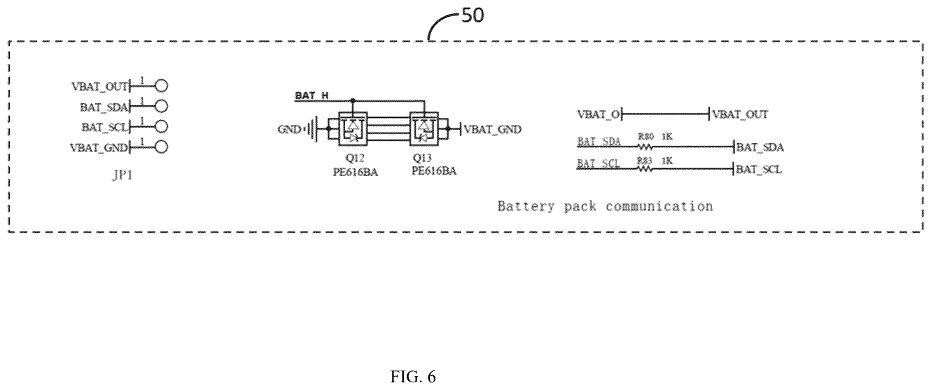

Referring to FIG. 6, the battery pack communication circuit 50 comprises a switch module. The switch module comprises a twelfth field-effect tube Q12 and a thirteenth field-effect tube Q13, and a connection point of a source of the twelfth field-effect tube Q12 and a source of the thirteenth field-effect tube Q13 is electrically connected with a pin 15 of the second chip U2. The pin 15 of the second chip U2 is a PT34/AIN4/RX/DMD/CC2B pin.

The second chip U2 is used for controlling the switch module to be switched on or off after determining series connection or parallel connection of the battery pack.

As shown in FIG. 6, there are four signal ends VBAT_OUT, BAT-SDA, BAT-SCL and VBAT_GND. According to information of the two signal ends BAT-SDA and BAT-SCL, it is determined whether the battery pack is connected in parallel or in series. For example, FIG. 2A and FIG. 2B constitute the integrated charging and discharging management circuit, and FIG. 3 to FIG. 6 are combined as an integrated circuit. FIG. 2A and FIG. 2B constitute the integrated charging and discharging management circuit, and FIG. 3 to FIG. 5 and FIG. 7 to FIG. 9 are combined to constitute an integrated circuit. It is determined whether the battery pack is connected in parallel or in series by input signals of BAT-SDA and BAT-SCL in the signal ends VBAT_OUT, BAT-SDA, BAT-SCL and VBAT_GND. For example, if a battery is of 30,000 mA, if two batteries are connected in parallel, 60,000 mA is provided.

In FIG. 6, when the device is normally plugged into the four signal ends VBAT_OUT, BAT-SDA, BAT-SCL and VBAT_GND, the battery packs are connected in parallel, and when the device is plugged into the four signal ends VBAT_OUT, BAT-SDA, BAT-SCL and VBAT_GND in reverse, the battery packs are connected in series. For example, SDA and SCL signals are 01 for parallel connection, SDA and SCL signals are 01 for series connection, and SDA and SCL signals are given to the second chip U2. When the second chip U2 does not recognize the SDA and SCL signals, the twelfth field-effect tube Q12 and the thirteenth field-effect tube Q13 comprised in the switch module are switched-off. When the SDA and SCL signals are recognized, the twelfth field-effect tube Q12 and the thirteenth field-effect tube are switched on, wherein the twelfth field-effect tube Q12 and the thirteenth field-effect tube Q13 are switched on by the pin 15 of the second chip U2 (pin PT34/AIN4/RX/DMD/CC2B). SDA and SCL signals are 00 by default, and the 1 twelfth field-effect tube Q12 and the thirteenth field-effect tube Q13 are switched off by default. When it is detected that a device is connected in forward, the battery packs are connected in parallel, and when it is detected that a device is connected in reverse, the battery packs are connected in series. When determining the or parallel connection of the battery pack, the second chip U2 outputs current and voltage normally, and the twelfth field-effect tube Q12 and the thirteenth field-effect tube Q13 of the switch module are switched on.

Exemplary, if the TypeC interface can only discharge for 3 hours, the TypeC interface can discharge for 6 hours after parallel connection, and the capacity becomes larger. If a voltage of the TypeC interface is only 10-20 V and a battery voltage is 9-12.6 V, then the battery voltage is 23.2 V after series connection, and the battery voltage rises to drive more devices. Further, when charging the battery pack after determining serial connection or parallel connection, the battery with low voltage can be controlled first, and the second chip U2 can determine a master and a slave according to the electric quantity, or determine the master or the slave according to a use state, and then the second chip U2 of the host performs control.

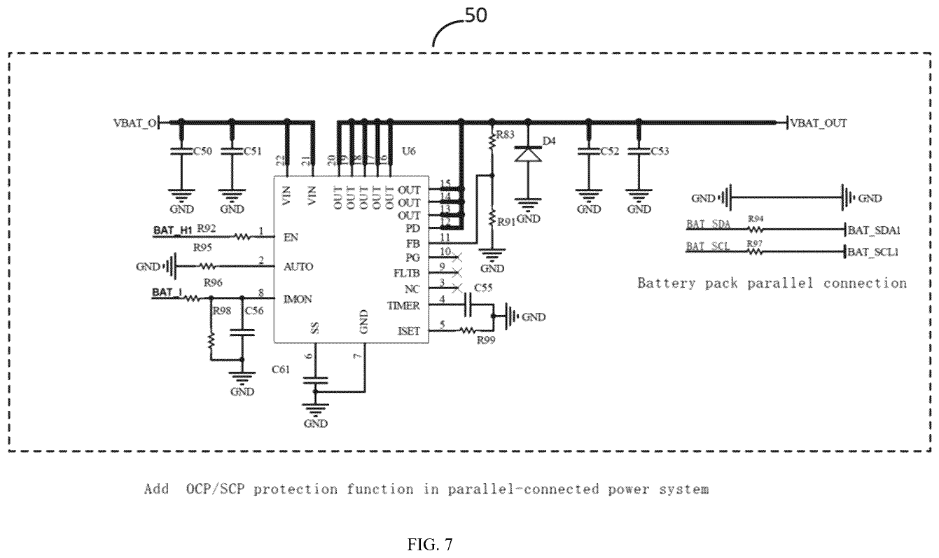

Referring to FIG. 7, the battery pack communication circuit 50 comprises a sixth chip U6, and a pin 8 of the sixth chip U6 is electrically connected with a pin 16 of the second chip U2. A pin 1 of the sixth chip U6 is electrically connected with the pin 15 of the second chip U2, and the second chip U2 is used for used for sending an enable signal to the pin 1 of the sixth chip U6 to start the sixth chip U6 after determining series connection or parallel connection of the battery pack. The sixth chip U6 is used for sending a read output current value of the sixth chip U6 to the pin 15 of the second chip U2. The pin 8 of the sixth chip U6 is an IMON pin, and the pin 16 of the second chip U2 is a PT33/AIN3/TX/DPD/CC1B pin. The pin 1 of the sixth chip U6 is an EN pin (enable end), and the pin 15 of the second chip U2 is a PT34/AIN4/RX/DMD/CC2B pin.

In FIG. 7, the pin 1 of the sixth chip U6 is an enable end (BAT-H1 signal), which activates the sixth chip U6 to turn on, and the pin 8 (IMON pin) of the sixth chip U6 reads output current value BAT_I thereof. In FIG. 7, there are signal ends BAT_SDA and BAT_SCL, and the second chip U2 determines series connection or parallel connection of the battery pack based on the signal ends BAT_SDA and BAT_SCL. When the communication between the signal ends BAT_SDA and BAT_SCL and the second chip U2 is completed, the second chip U2 sends a BAT_H1 signal to the sixth chip U6 to control the activation of the sixth chip U6.

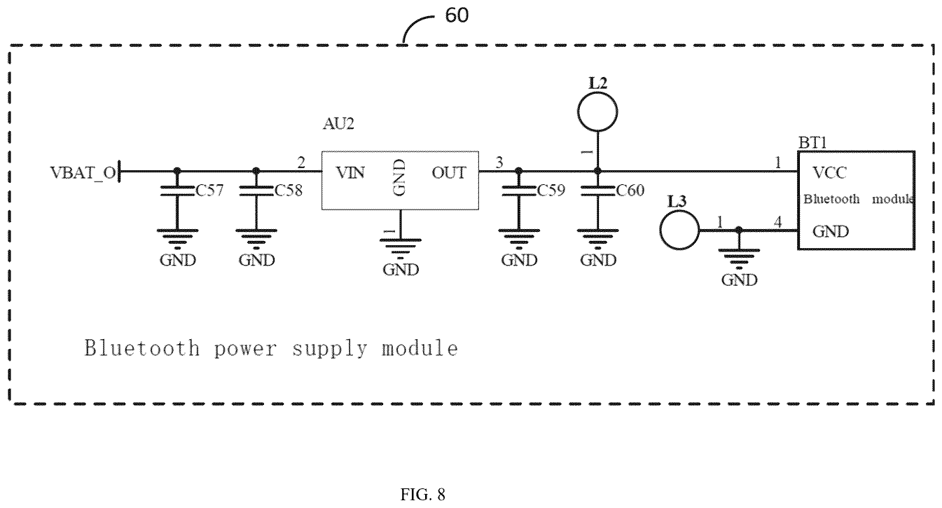

FIG. 8 shows a Bluetooth power supply module 60. The Bluetooth power supply module 60 comprises an amplifier AU2 and a Bluetooth module BT1, an input end of the amplifier AU2 is used for receiving a battery voltage VBAT_O, and an output end of the amplifier AU2 is electrically connected with the Bluetooth module BT1. A pin 1 of the amplifier AU2 is a GND pin, a pin 2 of the amplifier AU2 is an input end (VIN pin), and a pin 3 of the amplifier AU2 is an output end (OUT pin).

The Bluetooth power supply module 60 is used for locating a device position. The device may be a mobile phone, a tablet and other devices to be charged.

In this embodiment, the Bluetooth power supply module 60 may sense Bluetooth devices within a certain sensing range and locate related devices.

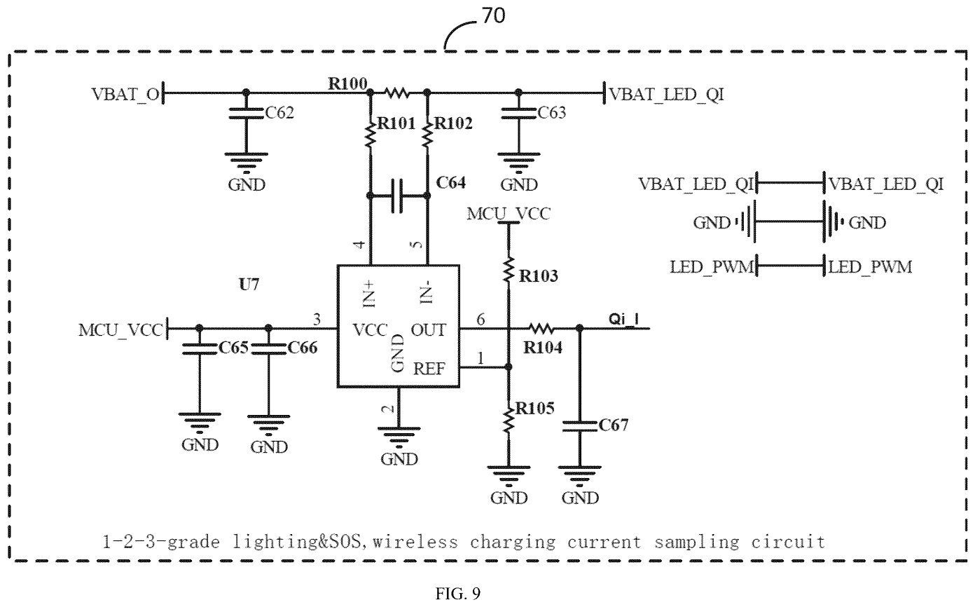

Referring to FIG. 9, FIG. 9 shows a lighting and sampling circuit 70, which comprises a seventh chip U7, and a pin 6 of the seventh chip U7 is electrically connected with a pin 27 of the second chip U2. The pin 6 of the seventh chip U7 is an OUT pin, and the pin 27 of the second chip U2 is a PT24/AIN12/DMB pin.

The lighting and sampling circuit 70 is used for detecting whether a load exists.

In this embodiment, the lighting and sampling circuit 70 may be used as a flashlight for lighting. The pin 6 (OUT pin) of the seventh chip U7 of the lighting and sampling circuit 70 is electrically connected with the pin 27 (PT24/AIN12/DMB pin) of the second chip U2, and it is judged whether a load exists by detecting a current Qi-I of the pin 6 of the seventh chip U7. It is judged whether an indicator needs to be lightened according to the fact that whether a load exists.

In this embodiment, the first chip U1, the second chip U2, the third chip U3, the fourth chip U4, the fifth chip U5, the sixth chip U6 and the seventh chip U7 are chips with corresponding pins, which can achieve corresponding functions.

According to the processing apparatus 1 of the battery pack, the charging and discharging management circuit 10 comprises the first chip and the charging and discharging interface 101, and the first chip is electrically connected with the charging and discharging interface 101; the logic control circuit 20 comprises the second chip; the pin 11 of the first chip is electrically connected with the pin 24 of the second chip; the pin 12 of the first chip is electrically connected with the pin 23 of the second chip; the battery pack protection circuit 30 comprises the fifth chip, the lithium battery protection circuit 301 and the battery pack turn-off protection circuit 302, the positive electrode of the battery pack is electrically connected with the pin 1 of the fifth chip, and the negative electrode of the battery pack is electrically connected with the pin 11, the pin CO and the pin 9 of the fifth chip through the lithium battery protection circuit; the first signal output end of the battery pack communication circuit 50 is electrically connected with the pin 13 of the second chip; the second signal output end of the battery pack communication circuit 50 is electrically connected with the pin 14 of the second chip; the battery pack communication circuit 50 is used for sending the control signal to the second chip through the first signal output end and the second signal output end; and the second chip is used for determining series connection or parallel connection of the battery pack according to the control signal. Series connection or parallel connection of the battery pack can be realized, and a working efficiency of the battery pack is improved.

### Embodiment 2

Moreover, the embodiments of the present disclosure provide an electronic device comprising the processing apparatus of the battery pack provided in Embodiment 1.

It should be noted that the electronic device in this embodiment comprises the processing apparatus 1 of the battery packed provided in the embodiments, can realize the processing process of the it should be noted that the processing apparatus 1 of the battery pack in Embodiment 1 and achieve the corresponding effect of the processing apparatus 1 of the battery pack in Embodiment 1, and will not be repeated here to avoid repetition.

The embodiments of the present disclosure have been described above with reference to the attached drawings, but the present disclosure is not limited to the above specific embodiments, which are only schematic, not restrictive. Under the inspiration of the present disclosure, those of ordinary skills in the art can make many forms without departing from the purpose of the present disclosure and the scope protected by the claims, which are all within the protection of the present disclosure.

### INDUSTRIAL APPLICABILITY

The present disclosure provides the processing apparatus of the battery pack and the electronic device, and belongs to the technical field of batteries. In the apparatus, the first chip of the charging and discharging management circuit is electrically connected with the charging and discharging interface; the pin 11 of the first chip U1 is electrically connected with the pin 24 of the second chip U2; the pin 12 of the first chip is electrically connected with the pin 23 of the second chip; the positive electrode of the battery pack is electrically connected with the pin 1 of the fifth chip, and the negative electrode of the battery pack is electrically connected with the pin 11, the pin CO and the pin 9 of the fifth chip; the first signal output end of the battery pack communication circuit is electrically connected with the pin 13 of the second chip; the second signal output end of the battery pack communication circuit is electrically connected with the pin 14 of the second chip; the battery pack communication circuit sends the control signal to the second chip; and the second chip is used for determining series connection or parallel connection of the battery pack according to the control signal. Series connection or parallel connection of the battery pack can be realized, and a working efficiency of the battery pack is improved.

In addition, it can be understood that the processing apparatus of the battery pack and the electronic device of the present disclosure are reproducible and may be used in various industrial applications. For example, the processing apparatus of the battery pack and the electronic device of the present disclosure may be used in the technical field of batteries.

We claim:

1. A processing apparatus of a battery pack, comprising: a charging and discharging management circuit, a logic control circuit, a battery pack protection circuit and a battery pack communication circuit, wherein:
the charging and discharging management circuit comprises a first chip and a charging and discharging interface, and the first chip is electrically connected with the charging and discharging interface;
the logic control circuit comprises a second chip;
a pin 11 of the first chip is electrically connected with a pin 24 of a second chip; and a pin 12 of the first chip is electrically connected with a pin 23 of the second chip;
the battery pack protection circuit comprises a fifth chip, a lithium battery protection circuit and a battery pack turn-off protection circuit, a positive electrode of the battery pack is electrically connected with a pin 1 of the fifth chip, and a negative electrode of the battery pack is electrically connected with a pin 11, a pin CO and a pin 9 of the fifth chip through the lithium battery protection circuit;
a first signal output end of the battery pack communication circuit is electrically connected with a pin 13 of the second chip; and a second signal output end of the battery pack communication circuit is electrically connected with a pin 14 of the second chip;
the battery pack communication circuit is used for sending a control signal to the second chip through the first signal output end and the second signal output end; and
the second chip is used for determining series connection or parallel connection of the battery pack according to the control signal.

2. The processing apparatus of the battery pack according to claim 1, wherein the battery pack communication circuit comprises a switch module, the switch module comprises a twelfth field-effect tube and a thirteenth field-effect tube, and a connection point of a source of the twelfth field-effect tube and a source of the thirteenth field-effect tube is electrically connected with a pin 15 of the second chip; and
the second chip is used for controlling the switch module to be switched on or off after determining series connection or parallel connection of the battery pack.

3. The processing apparatus of the battery pack according to claim 1, wherein the battery pack communication circuit comprises a sixth chip, and a pin 8 of the sixth chip is electrically connected with a pin 16 of the second chip; and a pin 1 of the sixth chip is electrically connected with a pin 15 of the second chip;
the second chip is used for sending an enable signal to the pin 1 of the sixth chip to start the sixth chip after determining series connection or parallel connection of the battery pack; and
the sixth chip is used for sending a read output current value of the sixth chip to the pin 15 of the second chip.

4. The processing apparatus of the battery pack according to claim 1, wherein the charging and discharging interface comprises an activation module, the activation module comprises a twelfth resistor, a second field-effect tube, an eleventh resistor, a thirteenth resistor and a seventeenth capacitor, a first end of the twelfth resistor is used for connecting with a power supply, a second end of the twelfth resistor is electrically connected with a base of the second field-effect tube, an emitter of the second field-effect tube is grounded, a grid of the second field-effect tube is electrically connected with a first end of the eleventh resistor and a first end of the thirteenth resistor, a second end of the thirteenth resistor is grounded, a first end of the seventeenth capacitor is electrically connected with the second end of the thirteenth resistor, a connection point of a second end of the seventeenth capacitor and a second end of the eleventh resistor is a control end of the activation module, and the control end of the activation module is electrically connected with an output end of the charging and discharging interface.

5. The processing apparatus of the battery pack according to claim 4, further comprising: a voltage control circuit, wherein the voltage control circuit comprises a third chip and a fourth chip, and a connection point of a pin 3 and a pin 5 of the fourth chip is electrically connected with a pin 16 of the third chip; a pin 4 of the fourth chip is electrically connected with a pin 10 of the second chip; and a pin 6 of the fourth chip is electrically connected with a pin 11 of the second chip; and
a fourth chip used for judging whether a device is inserted into the charging and discharging interface, and if a device is inserted, sending a corresponding level to the second chip.

6. The processing apparatus of the battery pack according to claim 5, wherein the fourth chip is further used for judging whether the charging and discharging is in a single-interface state or a dual-interface state, and when the charging and discharging is in the single-interface state, a TypeC interface or a USB interface has a fast charging function; and when the charging and discharging is in the dual-interface state, the TypeC interface and the USB interface have the fast charging function.

7. The processing apparatus of the battery pack according to claim 1, wherein the battery pack turn-off protection circuit comprises a seventh field-effect tube, a sixty-fifth resistor and a sixty-ninth resistor, a base of the seventh field-effect tube is electrically connected with a pin 14 of the fifth chip through the sixty-fifth resistor, an emitter of the seventh field-effect tube and a first end of the sixty-ninth resistor are grounded, and a connection point of a grid of the seventh field-effect tube and a second end of the sixty-ninth resistor is connected with a pin 2 of the second chip.

8. The processing apparatus of the battery pack according to claim 1, further comprising:
a Bluetooth power supply module, wherein the Bluetooth power supply module comprises an amplifier and a Bluetooth module, an input end of the amplifier is used for receiving a battery voltage, and an output end of the amplifier is electrically connected with the Bluetooth module; and
the Bluetooth power supply module is used for locating a device position.

9. The processing apparatus of the battery pack according to claim 8, further comprising:
a lighting and sampling circuit, wherein the lighting and sampling circuit comprises a seventh chip, and a pin 6 of the seventh chip is electrically connected with a pin 27 of the second chip; and
the lighting and sampling circuit is used for detecting whether a load exists.

10. An electronic device, comprising the processing apparatus of the battery pack according to claim 1.
